(19) United States
(12) Patent Application Publication
(10) Pub. No.: US 2020/0073000 A1
(43) Pub. Date: Mar. 5, 2020

(54) WIDE SPREAD SEISMIC SOURCE TOWING CONFIGURATION

(71) Applicants: Erik GODØY, Nesbru (NO); POLARCUS DMCC, Dubai (AE)

(72) Inventor: Mark Stephen ROGERS, Paceco (TP)

(21) Appl. No.: 16/499,360

(22) PCT Filed: Apr. 9, 2018
(86) PCT No.: PCT/NO2018/050096

§ 371 Date: Sep. 30, 2019

(30) Foreign Application Priority Data
May 9, 2017 (NO) 20170760

(51) Int. Cl. G01V 1/38

(52) U.S. Cl. CPC G01V 1/3808; G01V 1/3843; G01V 1/3817

(57) ABSTRACT

A method for conducting a seismic survey for collecting seismic data, the method may include towing strings of seismic sources coupled to a vessel, towing a plurality of lead-in cables coupled to the vessel and towing a plurality of streamers attached to the lead-in cables in a spreader cable at towing points. The method further includes towing a plurality of source cables such that the seismic source arrays are positioned with a wide spread of at least 125 meters that may distribute the near offset seismic data more evenly and creates a dataset of near offsets for imaging correctly.

### BACKGROUND OF THE INVENTION

The present disclosure relates generally to the field of seismic data acquisition configurations and, more particularly to towing strings of seismic sources in a wide spread that will distribute the near offset seismic traces more evenly and create a dataset of near offsets that may be imaged correctly.

In seismic surveying, one or more surface vessels tow a seismic source array and a receiver array comprising several streamers below a sea surface. The seismic sources emit acoustic pulses called “shots”, which penetrate into the underground geologic formations. Interfaces between materials with different elastic properties reflect and refract the acoustic waves, and seismic receivers in the receiver array record the echoes for later geophysical analysis.

Seismic towed streamer acquisition is a well-known method of exploring in the marine environment, which is especially helpful in determining the accurate location of mineral resources, such as oil and natural gas or the likes. This type of seismic data acquisition is known to generate seismic waves from at least one seismic source and to measure or record the produced waves using a plurality of seismic receivers in a “streamer”. A streamer consists of a plurality of receiver stations composed of one or more sensors. The streamers are generally ranging in length from a few meters to several thousand meters.

In marine seismic data acquisition, typically the seismic sources are towed in a narrow formation along the centre line of the vessel track. Therefore the near offset imaging is severely compromised when used with a wide lateral distribution of streamers, and results compare badly with high resolution surveys acquired with smaller streamer spreads.

PCT application no. PCT/GB2009/001177 discloses a system and a method relating to seismic imaging. It comprises streamers carrying a plurality of receivers towed by a vessel in a towing direction. The citation further comprises multiple seismic source arrays comprising a plurality of sources, which may overlap, and may be fired sequentially and repeatedly.

U.S. patent application Ser. No. 15/110,136 disclose a method of towing an array of marine seismic streamers coupled to a vessel. The array comprises a plurality of lead-in cables and streamers. The plurality of lead-in cables comprises an innermost lead-in cable and an outermost lead-in cable with respect to a centre line of the vessel. The method may also include towing a plurality of source cables and one or more seismic sources such that the one or more seismic sources are positioned between the innermost lead-in cable and the outermost lead-in cable.

Further in marine seismic acquisition there is typically a very large distance between the seismic source position and the closest seismic receiver. The seismic source to receiver distance results in data or traces missing from the acquisition for the small offsets between source and nearest receivers in the acquired seismic data records. In general it is very difficult to meet the data requirement.

Accordingly, it would be desirable to provide method and system that avoids the afore-described problems and drawbacks associated with seismic acquisitions and provides a seismic source/receiver configuration, or a tow vessel path configuration that improves target illumination, records near offset data with fewer passes and/or less time, may distribute the near offsets more evenly and creating a dataset of near offsets that is imaged correctly.

### SUMMARY OF THE INVENTION

In particular, the invention provides a method and system for conducting a seismic survey for collecting seismic data, the method includes towing a string of seismic source arrays coupled to a vessel, towing a plurality of lead-in cables coupled to the vessel and towing a plurality of streamers attached to the lead-in cables in a spreader cable at towing points. Further maintaining the seismic source arrays with a wide spread of at least 125 meters in-between the source and are coupled to the vessel with source cables. The seismic offset is measured from the top of the streamers which ranges from an offset of about 150 meters. The seismic source arrays are positioned in a wide spread of at least 125 meters with the source cables that may distribute the near offsets more evenly and creates a dataset of near offsets that may be imaged correctly.

Further, the seismic source arrays are maintained at selected positions, the seismic source array are towed one to left side, one to right side and one in the centre line of the vessel. The seismic source array is tri-source array, each seismic source array comprises two parallel arranged sub-source arrays including a cluster of guns spaced along a cable. Therefore, seismic source array comprising six sub-source arrays arranged substantially parallel in relation to each other in the towing direction.

Further, paravanes are attached to provide a lateral force on the spreader cable connected to the towing points in order to maintain fixed distances between leading ends of the streamers.

The present invention provides a seismic acquisition system, the system comprising, a string of seismic source arrays towed behind a vessel, a winch, a plurality of lead-in cables coupled to the vessel, and a receiver array comprising a plurality of streamers attached to the lead-in cables in a spreader cable at towing points. The seismic source arrays are maintained with wide spread of at least 125 meters in-between the source and coupled to the vessel with the source cables. The system further comprises one or more ropes connecting at least one of the seismic source arrays or source cables to one of the lead-in cables.

The streamers include several front floats, depth controllers, lateral steering devices and tail buoys. The streamer defining a proximal end and a distal end, the front floats are coupled to the proximal end, the tail buoys are coupled to the trailing end; the depth controller and the lateral steering devices are coupled along the streamer. The proximal end of the streamer may be associated with the front floats, where front floats may help maintain the depth of the streamer and/or associated portion of the spreader cable.

At the distal end of the streamers, away from the vessel, the tail buoys are coupled to the streamer. The Tail buoys may serve several purposes. For example, tail buoys may serve as a visual indication of the location of the end of the streamer. In some cases, the tail buoy may at least partially support the streamer. In particular, the streamer may be configured to be neutrally buoyant, or perhaps very slightly negatively buoyant depending on the salinity of the water.

Further, during the towing controlling depth of the trailing end of the streamer at least in part by the depth controllers; and the lateral steering devices are capable of imposing a lateral force on the streamers are used for steering, e.g. to compensate for lateral currents and adjust the towing depth

### BRIEF DESCRIPTION OF THE DRAWINGS

The present disclosure may be better understood by reference to one or more of these drawings in combination with the detailed description presented herein;

FIG. 1 is a diagram illustrating seismic acquisition system in accordance with various implementations of the present disclosure.

FIG. 2 is a diagram illustrating seismic surveying arrangement in accordance to with various implementations of the present disclosure.

### DETAILED DESCRIPTION OF THE INVENTION

In the following description, numerous details are set forth to provide an understanding of the present disclosure. However, it will be understood by those skilled in the art that the present disclosure may be practiced without these details and that numerous variations or modifications from the described embodiments are possible.

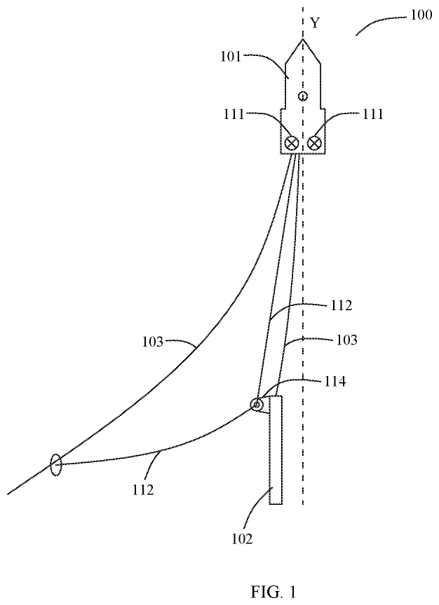

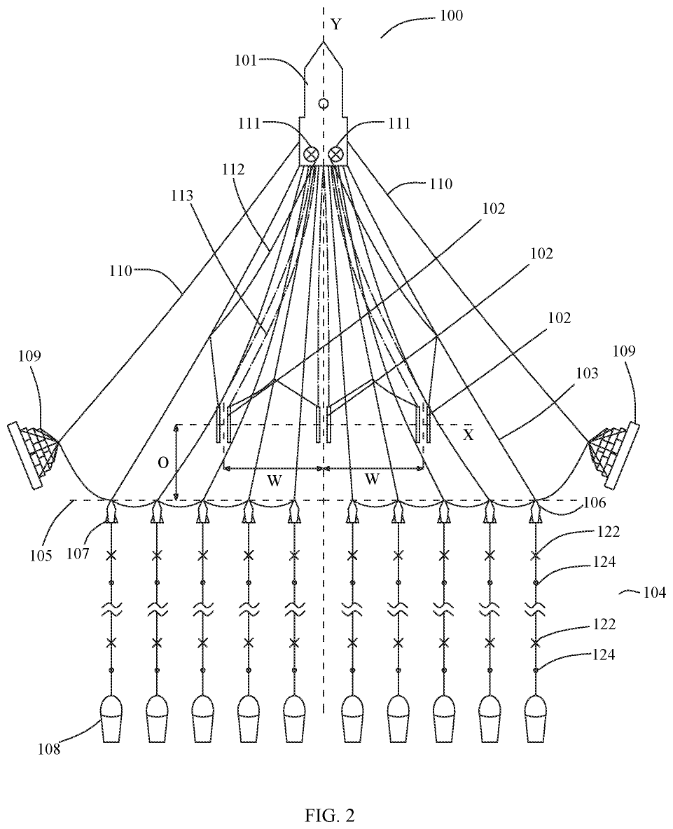

The invention will be explained with reference to the FIG. 1 and FIG. 2. FIG. 1 illustrates overview of a system 100 for marine seismic surveying comprising a seismic survey vessel 101 towing a string of seismic source arrays 102. The vessel 101 tows the seismic source arrays 102 below a sea surface with lead-in cables 103 and source cables 113 through a winch system. The winch system includes winches 111 on the vessel 101 and winch cables 112 that connect the seismic source arrays 102 and lead-in cables 103. In one implementation, the winch cable 112 connects the string of seismic source array 102 to the lead-in cable 103 or on the lead-in cable 103 through a cable guide 114 bolted to the string of seismic source array 102. In another implementation, the winch cable 112 may travel from the sources 102 to the lead-in 103, and then to the winch on the vessel 101.

FIG. 2 illustrates the marine seismic acquisition system 100 in accordance with various implementations described herein. The marine seismic acquisition system 100 may include a vessel 101 carrying control components, towing a plurality of seismic source arrays 102 and a receiver array with a plurality of streamers 104. The seismic source arrays 102 are arranged but not limited to a tri-source, each seismic source array comprises two parallel arranged sub-source arrays—gun-strings comprising a cluster of guns spaced along a cable. The seismic source arrays 102 are arranged symmetrical around a towing direction shown with direction Y.

FIG. 2 illustrates the system 100 for marine seismic surveying comprising a seismic survey vessel 101 towing three seismic source arrays 102 and ten streamers 104. The streamers 104 include several front floats 107, depth controllers 122, lateral steering devices 124 and tail buoys 108. The streamer defining a proximal end and a distal end, the front floats 107 are coupled to the leading end and the tail buoys 108 are coupled to the trailing end; the depth controller 122 and the lateral steering devices 124 are coupled along the streamer. The vessel 101 tows the seismic source arrays 102 and the receiver array comprising streamers 104 below a sea surface with lead-in cables 103, source cables 113 and a winch system including winches 111 on the vessel 101 and winch cables 112. In the FIG. 2, each streamer 104 is connected to a lead-in cable 103 in a towing point 106 on a spreader cable 105. Paravanes 109, also known as deflectors, provide a lateral force on a spreader cable 105 connected to the towing points 106 in order to maintain fixed distances between leading ends of the streamers 104. Referring to FIG. 2, the length of lead-in cables 103, positions of the paravanes 109 and known lengths of the spreader cable 105 may help to determine the towing point 106 for towing streamers 104.

In the proximal end of the streamer 104 may be associated with the front floats 107, where front floats 107 may help maintain the depth of the streamer 104 and/or associated portion of the spreader cable 105. At the distal end of the streamers, away from the vessel, the tail buoys 108 are coupled to the streamer. The tail buoys 108 may be coupled at the streamer 104 distal ends carry radar reflectors, the tail buoys 108 may be coupled to the streamer 104 by any suitable mechanism. Tail buoy 108 may serve several purposes. For example, tail buoy 108 may serve as a visual indication of the location of the end of the streamer 104. In some cases, the tail buoy 108 may at least partially support the streamer 104. In particular, the streamer 106 may be configured to be neutrally buoyant, or perhaps very slightly negatively buoyant depending on the salinity of the water. Further, during the towing controlling depth of the trailing end of the streamer at least in part by the depth controllers 122, the depth controllers 122 may maintain the depth of the streamer 104. Further, the lateral steering devices 124 are known devices of any kind capable of imposing a lateral force on the streamers 104 and are used for steering, e.g. to compensate for lateral currents and adjust the towing depth.

The placement, length, amount, and position of the lead-in cables 103, source cables 113, winch cables 112, Paravanes 109, seismic source arrays 102, streamers 104, front floats 107, depth controllers 122, lateral steering devices 124 and tail buoys 108 may be changed. For example, in order to meet a set of specifications for a seismic acquisition, the number of streamers 104 may be increased or decreased, or the length of streamers may be increased or decreased.

The lead-in cables 103 are attached to streamers 104 with spreader cable 105. Further the outermost lead-in cables are attached to paravanes 109; the paravanes 109 are coupled with the vessel with ropes 110. The lead-in cables 103 may vary in length. In FIG. 2, each streamer 104 is connected to a lead-in cable 103 in a towing point 106. The number of streamers 104 may vary however there are ten streamers 104 have been used, five on each side from the centre line Y of the vessel 101. Each streamer 104 also carries several lateral steering devices 124 able to exert a force on the streamer 104 lateral to the towing direction and/or vertically.

The seismic source arrays 102 are positioned with wide spread W of at least 125 meters with source cables 113. One seismic source array 102 is coupled to left, one at right side of the vessel 101 and one in the centre line Y of the vessel 101. As illustrated in FIG. 2, the seismic acquisition system 100 is a tri-seismic source array 102 with wide spread W of 125 meters.

FIG. 2 illustrates, which may be referred to as an offset, between the sources 102 and the beginning of the active portion of the streamers 104. From the top of the streamers 104, the seismic offset O from the line X is shown in the FIG. 2 and ranges from an offset of about or approximately 150 meters. Sources 102 and source cables 103 are towed between the innermost lead-in cables 103 and the outermost lead-in cables 103. The streamers 104 may be towed at a greater depth than the source 102, so that the sources 102 do not interfere with the streamers 104.

To determine acquisition system parameters, such as lead-in cables 103 length, source cables 113 length, rope 110 lengths, winch cables 112 length, and types and/or locations of paravanes 109, one or more towing simulations may be generated for a particular seismic survey. The towing simulations may also be used in the recovery or deployment of various spread components for the seismic survey.

In one implementation, the source cable 113 may be attached to multiple lead-in cables 103. In another implementation, the source cable 113 may travel from the sources 102, to the lead-in 103, and then to the winch 111 on the vessel 101. In this implementation, the sources 102 may be repositioned by altering the source cables 113 length using the winch 111 on the vessel 101.

During acquisition, the seismic sources 102 and the seismic streamers 104 may be deployed from the vessel 101. The seismic sources 102 may be activated individually or substantially simultaneously with other sources to emit seismic energy in the form of an acoustic through the water. The acoustic wave may be recorded by seismic receivers in the receiver array, may be converted to electrical signals, digitized and transmitted a recording system in the vessel.

It should be apparent to persons skilled in the arts that various modifications and adaptation of this structure described above are possible without departure from the spirit of the invention the scope of which is defined in the appended claim.

1-14. (canceled).

15. A method of seismic acquisition, comprising:
towing strings of seismic source arrays behind a vessel;
towing a plurality of lead-in cables coupled to the vessel; and
towing a receiver array comprising a plurality of streamers, the streamers are attached to the lead-in cables in a spreader cable at towing points, wherein maintaining the seismic source array with a wide spread of at least 125 meters in-between the sources, the sources are coupled to the vessel with source cables, wherein requiring the seismic offset (O) from the top of the streamers which provides for an offset of about 150 meters.

16. The method of claim 15, wherein the seismic source arrays are at a selected position, one is coupled to left side, one to right side and one in the centre line (Y) of the vessel.

17. The method of claim 15, wherein the seismic source arrays are positioned in tri-seismic source, each seismic source array comprises two parallel arranged sub-source arrays including a cluster of guns spaced along a cable.

18. The method of claim 15, wherein further paravanes are attached to provide a lateral force on the spreader cable connected to the towing points in order to maintain fixed distances between leading ends of the streamers.

19. The method of claim 15, wherein the wide spread (W) of the seismic source arrays distribute the near offsets more evenly and create a dataset of near offsets that is imaged correctly.

20. The method of claim 15, wherein the lead-in cables comprise an innermost lead-in cable and an outermost lead-in cable with respect to a centre line (Y) of the vessel.

21. The method of claim 15, wherein the streamers are at least 75 meters in length.

22. The method of claim 15, wherein the seismic source arrays are positioned at lesser depth than the streamers.

23. The method of claim 15, wherein the seismic source arrays are deployed in the body of water such that the seismic offset (O) is measured over the top of the streamer.

24. A seismic acquisition system, comprising:
a string of seismic source arrays towed behind a vessel;
a winch;
a plurality of lead-in cables coupled to the vessel; and
a plurality of streamers attached to the lead-in cables in a spreader cable at towing points, wherein the seismic source arrays are maintained with wide spread (W) of at least 125 meters in-between the source and are coupled to the vessel with source cables, and wherein the streamers are deployed or recovered independently of each other with lead-in cables.

25. The seismic acquisition system of claim 24, wherein further comprising one or more ropes connecting at least one of the seismic source arrays or source cables to one of the lead-in cables.

26. The seismic acquisition system of claim 24, wherein the seismic offset (O) from the top of the streamers which ranges from an offset of about 150 meters.

27. The seismic acquisition system of claim 24, wherein the streamers comprises several front floats, depth controllers 122, lateral steering devices 124 and tail buoys.

28. The seismic acquisition system of claim 24, wherein further paravanes are attached to provide a lateral force on the spreader cable connected to the towing points in order to maintain fixed distances between leading ends of the streamers.
